(19) United States
(12) Patent Application Publication
(10) Pub. No.: US 2003/0169491 A1
(43) Pub. Date: Sep. 11, 2003

(54) Impaired vision assist system and method

(76) Inventors: Eliyahu Bender, Jerusalem (IL); Nissim Asida, Nof Ayalon (IL)

Correspondence Address: Jeffrey S Sharp, Marshall Gerstein & Borun, Sears Tower Suite 6300, 233 S Wacker Drive, Chicago, IL, 60606-6357, US

(21) Appl. No.: 10/332,603

(22) PCT Filed: Jul. 10, 2001
(86) PCT No.: PCT/IL01/00633

(51) Int. Cl. G02B 1/00; G02B 13/14; G02B 5/20; F21V 9/06

(52) U.S. Cl. 359/356; 359/350; 359/355; 359/361

(57) ABSTRACT

A night vision system, suitable for vehicular use, including an infra-red detector mounted on a vehicle, a display mounted on the vehicle, a single-element lens mounted upstream of the infra-red detector so as to direct light from a scene onto the infra-red detector, and circuitry operative to receive a detector output from the infra-red detector and to provide an image output based on the detector output to the display. The system is suitable for applications other than vehicular use, where a comparatively narrow field of view is to be imaged.

### FIELD OF THE INVENTION

The present invention relates to the field of forward-looking infra-red cameras for use in night vision enhancement, especially for vehicular application.

### BACKGROUND OF THE INVENTION

One of the most hazardous aspects of driving at night, is that the headlight system of the vehicle generally has a limited level of illuminating power, thus limiting the range of visibility of the driver. Furthermore, in conditions of limited visibility, such as fog, mist, smoke or likewise, the quality and range of visibility of the driver is limited not only by the limited transmission of visible light through those media, but also because of the high level of back-scattered light from a conventional active headlight system.

Systems for imaging the thermal radiation emitted by an object or from an environment to be viewed, are well known in the art. Such systems are known as Forward Looking Infra Red systems, or FLIR systems. They generally include an infra-red imaging system utilizing a cryogenic detector. Because of the high cost of these prior art systems, their use has largely been confined to applications capable of justifying the costs, such as military applications. Recently, the development of uncooled detector arrays capable of operation in the thermal infra-red spectral range, typically of 7 to 14 microns wavelength, has opened the way to much less costly FLIR cameras, and their potentially widespread use in cost-sensitive consumer applications.

One such application is for use in providing the driver of a road vehicle with an infrared image of the field of view in front of him. In that way, at night the driver can discriminate between the background and objects which emit higher levels of infra-red radiation than the background, at a much longer range than he could with only the conventional headlight systems currently used for night driving. In this way, the driver is generally able to see warm objects such as persons and animals sooner and further. Furthermore, the use of passive infra-red radiation largely overcomes the problems mentioned above of visibility in fog, mist or smoke, as encountered with active illumination systems in the visible range.

In order for such systems to become widely accepted for use in consumer applications, such as the above-mentioned vehicular application, the cost of the camera must be reduced to minimal levels. One of the most costly parts of any FLIR camera is the infra-red focusing optic, which is generally manufactured of an exotic IR transparent material such as germanium, zinc sulphide, zinc selenide, gallium arsenide, AMTIR, or calcium fluoride. In prior art systems, the imaging lenses are often equipped with an aspheric surface formed by diamond turning, which too is a costly process. The focusing optics is thus one of the most critical assemblies in prior art FLIR cameras, with regard to the cost of such systems.

Though the optical performance required by a IR night vision system directed at a consumer or civilian market application is significantly less than that required by a high-resolution, high-sensitivity military system, the cost of the optical focusing assembly still remains a critical factor in providing a FLIR camera for widespread use, such as for vehicular use, or for surveillance use.

In U.S. Pat. No. 5,479,292, to M. Yoshikawa et al, for “Infrared wide-angle single lens for use in an infrared optical system”, hereinafter ‘Yoshikawa’) hereby incorporated by reference in its entirety, there is described a temperature sensing device suitable for controlling the operation of a room air conditioning unit, by detecting the positions of human bodies in the room or the temperature conditions in the room. The device incorporates an infra-red wide-angle single-element lens with an object stop comparatively close to the lens. The inventors assert that the cost of this device is acceptably low for its intended use, since the optical design incorporates only one lens and a stop.

This lens design, though, would appear to be unsuitable for use in a vehicular FLIR camera imaging application, for a number of reasons. Firstly, it is designed to be a wide angle lens, with a full angle field of view of 70°. The requirements for vehicular FLIR use, on the other hand, are for a narrow field of view, typically of the order of 12° horizontally and 9° vertically. The field of view requirements for other imaging applications with a medium range field of view is typically between that suggested for the vehicular application, and that described in Yoshikawa, and is typically up to approximately 60°.

Secondly, the thickness of the Yoshikawa lens is comparatively large, and the raw material cost is consequently comparatively high. Though the lens described in the main embodiment of the Yoshikawa et al. patent is made of silicon, germanium may well provide better optical performance for an application such as a vehicular FLIR. If the Yoshikawa lens were made of germanium, it is estimated that a 25 mm focal length lens would weigh more than 30 grams. Since the world supply of germanium is limited, minimizing the weight of germanium used in a potentially high volume application, such as in a system for vehicular or surveillance use, has raw material conservation implications far beyond simple system cost considerations.

Finally, a ray tracing and optimization analysis of the Yoshikawa prior art lens design for the case of 25 mm focal length shows that it would appear to have a comparatively high level of spherical aberration and a comparatively poor MTF. Though the levels of these system performance parameters are adequate for the intended use as a wide angle, short focal length, temperature sensing lens, they would not be generally considered adequate for use in an imaging application, where resolution and general overall optical performance requirements are considerably higher.

There therefore exists a serious need for an infra red imaging camera for use in a vehicular night vision system, or in a night vision system for other narrow or medium field of view applications, which will have low cost, good optical performance over its field of view, and will use a minimum of IR transparent raw material.

The disclosures of all publications mentioned in this section and in the other sections of the specification, are hereby incorporated by reference, each in its entirety.

### SUMMARY OF THE INVENTION

The present invention thus seeks to provide a new night vision enhancement system particularly suitable for use in vehicular or surveillance applications, using a FLIR camera incorporating a single-element lens focusing assembly, designed to provide good optical performance coupled with low cost. Though the invention is primarily described in this specification in terms of its use in vehicular applications, it is to be understood that it is equally applicable to other night vision applications requiring a narrow or medium field of view and good optical performance, including, but not limited to such applications as surveillance applications, including law enforcement, perimeter security, forest-fire surveillance; fire-fighting applications; and industrial or marine applications, such as search and rescue, energy auditing, engine inspection, and the like.

In the vehicular embodiment, the FLIR camera provides a video signal representation of the thermal infra-red field of view forward of the vehicle. This signal is converted into a reconstructed real-time video image, and preferably displayed to the driver by means of a Head-Up Display (HUD). The position of the image projected by the HUD onto the windshield is preferably adjustable, to compensate for the differing heights of different driver's eyes. The HUD may be of a type well-known in the art.

For other applications, such as industrial or surveillance applications, the image may preferably be displayed on a conventional flat-panel display screen, such as a monochrome version of the LCD screens familiar from video cameras. Alternatively and preferably, a built-in display may be used, which is viewed by a conventional eyepiece, such as the embodiment shown in FIG. 9 of the PCT Application by some of the present applicants, published as WO 99/60429A1 for “Precision Double-sided Aspheric Element”, hereby incorporated by reference in its entirety.

There is thus provided in accordance with a preferred embodiment of the present invention, a FLIR camera with an optical lens assembly which utilizes a single, thin, positive lens manufactured of a material transparent in the IR range to be imaged, which is typically 8 to 12 μm, or 7 to 14 μm. The lens preferably has spherical optical surfaces, a factor which also contributes to the low cost of the device. According to a further preferred embodiment, the lens may have an aspheric surface, thereby providing either improved optical performance, or a lens with a lower material content, or both, at the expense of a somewhat higher manufacturing cost. According to yet a further preferred embodiment, the lens may have both of its surfaces aspheric, thereby providing even more improved optical performance, or even lower material content, or both. Such a double-sided aspheric lens is described in the above-mentioned PCT Application published as WO99/60429A1. According to even further preferred embodiments of the present invention, any surface of the lens may be provided with a diffractive optics profile, to further improve performance, especially in reducing the effects of chromatic aberrations.

The lens assembly preferably includes an aperture stop. For the narrow field of view applications, such as the vehicular application, the stop is preferably located on the object side of the lens at a distance greater than the focal length of the lens. For closer range, wider field of view applications, the stop may preferably be closer to the lens than the focal distance, and may even be situated on the detector side of the lens.

The lens assembly is preferably constructed according to the results of ray tracing optimizations to maximize a merit function, which is preferably built of a number of desired performance parameters of the FLIR camera. The parameters may include the modulation transfer function (MTF) of the lens assembly as a function of field position, the RMS spot size of the focused beams from the whole range of field positions, the image distortion and the relative image illumination. It is to be understood though, that these parameters are only typically used parameters for optimizing lens performance, and that other parameters and combinations may equally well be used in the merit function. The invention is thus not deemed to be limited to the specific parameters mentioned hereinabove.

The optimization procedure results in defined values of the radii of curvature of the lens surfaces, the aperture stop diameter and its position, the focal length of the lens, and the lens thickness, for defined values of the index of refraction of the lens material. For preferred embodiments using one or more aspheric surfaces, the surfaces are defined also by means of conic constant and aspheric coefficients. For preferred embodiments using a diffractive profile, the surfaces are also defined by the diffractive coefficients. The lens assemblies thus defined then have optimal optical performance with minimal aberrations within the design criteria chosen for the merit function.

According to further preferred embodiments of the present invention, the FLIR camera is provided with an uncooled focal plane array (FPA) which detects the image focused by the lens assembly. The FPA preferably uses bolometers as the detector array elements. Alternatively and preferably, the detector array elements may be ferroclectric or of any other suitable type. According to further preferred embodiments of the present invention, the camera is located at the front of the vehicle, and images the forward IR field of view of the road scene ahead. The camera is preferably located within the front grill of the vehicle, forward of the radiator, to avoid thermal interference therefrom.

The video signal from the camera is preferably processed by means of a signal processing and control unit, and, in the case of the vehicular embodiments, is then preferably transferred to the HUD projection unit for display of the image on the windshield in front of the driver. A preferred position on the windshield for projecting the image is above the driver's head, so that the driver can shift his view effortlessly from the HUD image to the real view, in much the same way as he uses the rear view mirror. The windshield preferably has a semi-transparent, slightly reflecting film coating in that area, to allow the projected HUD image to be visible to the driver. According to further preferred embodiments of the present invention, the HUD unit preferably includes control circuitry operative to modulate the light level of the projected image as a function of the outside ambient light level, and alternatively or additionally, according to individual driver preference. A height control for adjusting the height of the display to match each individual driver's height is also preferably provided.

There is also provided in accordance with another preferred embodiment of the present invention, an infra red imaging lens assembly including a single thin lens as the only focussing element, the lens having a first convex surface facing the infra red object, and a second concave surface facing an imaging plane of the lens, and further having an aperture stop disposed between the object plane and the first surface of the lens.

The lens typically satisfies the following conditions:

5°<FOV<60° (1)

0.5<F<4 (2)

0.7f<r1<3.1f (3)

f<r2<infinity (4)

1.4<n<4.5 (5)

0.4f<bf<f (6)

0.05f<t<f (7)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens.

The values of r₁ and r₂ are of opposite sign to those of Yoshikawa, since the first surface of the lens according to the present invention is convex and the second concave, the opposite to that of Yoshikawa.

Preferably the lens satisfies the following conditions:

8°<FOV <35° (1)

0.7<F<2.8 (2)

0.7f<r1<3.1f (3)

f<r2<infinity (4)

2<n<4.5 (5)

0.7f<bf<f (6)

0.05f<t<0.3f (7)

−0.1f<d<10f (8)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens;

d is the position of the stop relative to the center of the front-facing surface of the lens—a positive value means that the stop is forward of the lens and a negative value means that the stop is behind the center of the front-facing surface of the lens.

More preferably the lens satisfies the following conditions:

8°<FOV <35° (1)

0.7<F<2.8 (2)

0.7f<r1<3.1f (3)

f<r2<infinity (4)

2<n<4.5 (5)

0.7f<bf<f (6)

0.05f<t<0.3f (7)

0.7f<d<10f (8)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens;

d is the position of the stop relative to the center of the front-facing surface of the lens—a positive value means that the stop is forward of the lens and a negative value means that the stop is behind the center of the front-facing surface of the lens.

The lens surfaces may be both spherical or both aspheric, or one spherical and the other aspheric. In the case of an aspheric lens, the conic constant may range between negative infinity and +50, and other aspheric coefficients may have non-zero values in order to provide fine optimization to the lens.

In accordance with another preferred embodiment of the present invention, the aperture stop is separated from the front facing surface of the lens by more than the focal length of the lens. In accordance with a more preferred embodiment of the invention, the aperture stop is separated from the front facing surface of the lens by more than twice the focal length of the lens.

There is further provided in accordance with additional preferred embodiments of the present invention, a vehicular night vision system including an infra-red detector mounted on a vehicle, a display mounted on the vehicle, a focusing assembly consisting of a single-element lens only, mounted upstream of the infra-red detector, for directing infrared radiation from a scene onto the infra-red detector, and circuitry operative to receive a detector output from the infra-red detector and to provide an image output based on the detector output to the display.

Further in accordance with a preferred embodiment of the present invention the single-element lens and the infra-red detector of the vehicular night vision system are mounted in a housing and together define an infra-red camera which is mounted by means of the housing, on the vehicle in a forward looking orientation.

Additionally or alternatively, in accordance with a preferred embodiment of the present invention the display is a transparent display mounted on a vehicle so as to overlie at least a portion of the vehicle windshield.

Further in accordance with a preferred embodiment of the present invention the camera of the vehicular night vision system includes an aperture stop which is distanced forwardly of a front facing surface of the single-element lens by a distance which exceeds the focal length of the single-element lens.

Moreover in accordance with a preferred embodiment of the present invention the camera includes an aperture stop which is distanced forwardly of a front facing surface of the single-element lens by a distance which exceeds twice the focal length of the single-element lens.

Still further in accordance with another preferred embodiment of the present invention there is no optical element having optical power interposed between the single-element lens of the vehicular night vision system, and the scene.

Alternatively in accordance with a preferred embodiment of the present invention the camera of the vehicular night vision system includes an aperture stop which is distanced rearwardly of center of a front facing surface of the single-element lens by a distance which is less than the focal length of the single-element lens.

Further in accordance with a preferred embodiment of the present invention the camera of the vehicular night vision system includes a single element lens satisfying the following conditions:

5°<FOV <60° (1)

0.5<F<4 (2)

0.7f<r1<3.1f (3)

f<r2<infinity (4)

1.4<n<4.5 (5)

0.4f<bf<f (6)

0.05f<t<f (7)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens.

Preferably the single element lens of the camera of the vehicular night vision system satisfies the following conditions:

8°<FOV<35° (1)

0.7<F<2.8 (2)

0.7f<r1<3.1f (3)

f<r2<infinity (4)

2<n<4.5 (5)

0.7f<bf<f (6)

0.05f<t<0.3f (7)

−0.1f<d<10f (8)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens is and the Gaussian image plane;

t is the center thickness of the lens;

d is the position of the stop relative to the center of the front-facing surface of the lens—a positive value means that the stop is forward of the lens and a negative value means that the stop is behind the center of the front-facing surface of the lens.

More preferably the single element lens of the camera of the vehicular night vision system satisfies the following conditions:

8°<FOV<35° (1)

0.7<F<2.8 (2)

0.7f<r1<3.1f (3)

f<r2<infinity (4)

2<n<4.5 (5)

0.7f<bf<f (6)

0.05f<t<0.3f (7)

0.7f<d<f (8)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens;

d is the position of the stop relative to the center of the front-facing surface of the lens—a positive value means that the stop is forward of the lens and a negative value means that the stop is behind the center of the front-facing surface of the lens.

There is also provided in accordance with another preferred embodiment of the present invention a vehicle having night vision functionality including a motor vehicle, an infra-red detector mounted on the vehicle, a display mounted on the vehicle, a focusing assembly consisting of a single-element lens only, mounted upstream of the infra-red detector, for directing infrared radiation from a scene onto the infra-red detector, and circuitry operative to receive a detector output from the infra-red detector and to provide an image output based on the detector output to the display.

Further in accordance with a preferred embodiment of the present invention, in the above-mentioned vehicle having night vision functionality, the single-element lens and the infra-red detector are mounted in a housing and together define an infra-red camera which is mounted by means of the housing on the vehicle in a forward looking orientation.

Additionally or alternatively, in accordance with a preferred embodiment of the present invention, the display in the above-mentioned vehicle is a transparent display mounted on the vehicle so as to overlie at least a portion of a vehicle windshield.

Still further in accordance with a preferred embodiment of the present invention, in the above-mentioned vehicle, there is no optical element having optical power interposed between the single-element lens and the scene.

Further in accordance with a preferred embodiment of the present invention the camera of the above-mentioned vehicle includes an aperture stop which is distanced forwardly of a front facing surface of the single-element lens by a distance which exceeds the focal length of the single-element lens.

Moreover in accordance with a preferred embodiment of the present invention, the camera of the above-mentioned vehicle includes an aperture stop which is distanced forwardly of a front facing surface of the single-element lens by a distance which exceeds twice the focal length of the single-element lens.

Preferably the camera includes an aperture stop which is distanced forwardly of a front facing surface of the single-element lens by a distance which exceeds the focal length of the single-element lens.

Additionally or alternatively the camera includes an aperture stop which is distanced forwardly of a front facing surface of the single-element lens by a distance which exceeds twice the focal length of the single-element lens.

Still further in accordance with a preferred embodiment of the present invention there is no optical element having optical power interposed between the single-element lens of the camera of the above-mentioned vehicle and the scene.

Alternatively in accordance with a preferred embodiment of the present invention the camera in the above-mentioned vehicle includes an aperture stop which is distanced rearwardly of the center of a front facing surface of the single-element lens by a distance which is less than the focal length of the single-element lens.

Further in accordance with a preferred embodiment of the present invention the camera in the above-mentioned vehicle includes a single element lens satisfying the following conditions:

5°<FOV<60° (1)

0.5<F<4 (2)

0.7f<r1<3.1f (3)

f<r2<infinity (4)

1.4<n<4.5 (5)

0.4f<bf<f (6)

0.05<t<f (7)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens.

Preferably the single element lens in the camera of the above-mentioned vehicle satisfies the following conditions:

8°<FOV<35° (1)

0.7<F<2.8 (2)

0.7f<r1<3.1f (3)

f<r2<infinity (4)

2<n<4.5 (5)

0.7f<bf<f (6)

0.05f<t<0.3f (7)

−0.1f<d<10f (8)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens;

d is the position of the stop relative to the center of the front-facing surface of the lens—a positive value means that the stop is forward of the lens and a negative value means that the stop is behind the center of the front-facing surface of the lens.

More preferably the single element lens in the camera of the above-mentioned vehicle satisfies the following conditions:

8°<FOV<35° (1)

0.7<F<2.8 (2)

0.7f<r1<3.1f (3)

f<r2<infinity (4)

2<n<4.5 (5)

0.7f<bf<f (6)

0.05f<t<0.3f (7)

0.7f<d<10f (8)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens;

d is the position of the stop relative to the center of the front-facing surface of the lens—a positive value means that the stop is forward of the lens and a negative value means that the stop is behind the center of the front-facing surface of the lens.

There is thus provided in accordance with yet another preferred embodiment of the present invention a night vision system including an infra-red detector, a display, a focusing assembly consisting of a single-element lens only, mounted upstream of the infra-red detector, for directing infrared radiation from a scene onto the infra-red detector, and circuitry operative to receive a detector output from the infra-red detector and to provide an image output based on the detector output to the display.

Further in accordance with a preferred embodiment of the present invention the single-element lens and the infra-red detector of the night vision system are mounted in a housing and together define an infra-red camera.

Preferably the display is a transparent display.

Still further in accordance with a preferred embodiment of the present invention there is no optical element having optical power interposed between the single-element lens of the night vision system and the scene.

Additionally in accordance with a preferred embodiment of the present invention the camera of the night vision system includes an aperture stop which is distanced forwardly of a front facing surface of the single-element lens by a distance which exceeds the focal length of the single-element lens.

Moreover in accordance with a preferred embodiment of the present invention the camera of the night vision system includes an aperture stop which is distanced forwardly of a front facing surface of the single-element lens by a distance which exceeds twice the focal length of the single-element lens.

Additionally in accordance with a preferred embodiment of the present invention there is no optical element having optical power interposed between the single-element lens of the night vision system and the scene.

Alternatively in accordance with a preferred embodiment of the present invention the camera of the night vision system includes an aperture stop which is distanced rearwardly of the center of front facing surface of the single-element lens by a distance which is less than the focal length of the single-element lens.

Further in accordance with a preferred embodiment of the present invention the camera of the night vision system includes a single element lens satisfying the following conditions:

5°<FOV<60° (1)

0.5<F<4 (2)

0.7f<r1<3.1f (3)

f<r2<infinity (4)

1.4<n<4.5 (5)

0.4f<bf<f (6)

0.05f<t<f (7)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens.

Preferably the single element lens of the camera of the night vision system satisfies the following conditions:

8°<FOV<35° (1)

0.7<F<2.8 (2)

0.7f<r1<3.1f (3)

f<r2<infinity (4)

2<n<4.5 (5)

0.7f<bf<f (6)

0.05f<t<0.3f (7)

−0.1f<d<10f (8)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens;

d is the position of the stop relative to the center of the front-facing surface of the lens—a positive value means that the stop is forward of the lens and a negative value means that the stop is behind the center of the front-facing surface of the lens.

More preferably the single element lens of the camera of the night vision system satisfies the following conditions:

8°<FOV<35° (1)

0.7<F<2.8 (2)

0.7f<r1<3.1f (3)

f<r2<infinity (4)

2<n<4.5 (5)

0.7f<bf<f (6)

0.05f<t<0.3f (7)

0.7f<d<10f (8)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens;

d is the position of the stop relative to the center of the front-facing surface of the lens—a positive value means that the stop is forward of the lens and a negative value means that the stop is behind the center of the front-facing surface of the lens.

There is thus also provided in accordance with another preferred embodiment of the present invention a method for vehicular night vision including mounting an infra-red detector on a vehicle, mounting a display on the vehicle, and providing a single-element lens upstream of the infra-red detector so as to direct infrared radiation from a scene onto the infra-red detector, and receiving a detector output from the infra-red detector and providing an image output based on the detector output to the display.

Further in accordance with a preferred embodiment of the present invention the single-element lens and the infra-red detector used in the above-mentioned method are mounted in a housing and together define an infra-red camera which is mounted by means of the housing on the vehicle in a forward looking orientation.

Additionally or alternatively, in accordance with a preferred embodiment of the present invention, the display used in the above-mentioned method is a transparent display mounted on the vehicle so as to overlie at least a portion of a vehicle windshield.

Additionally in accordance with a preferred embodiment of the present invention, in the above-mentioned method, there is no optical element having optical power interposed between the single-element lens and the scene.

Moreover in accordance with a preferred embodiment of the present invention the camera used in the above-mentioned method includes an aperture stop which is distanced forwardly of a front facing surface of the single-element lens by a distance which exceeds the focal length of the single-element lens.

Further in accordance with a preferred embodiment of the present invention the camera used in the above-mentioned method includes an aperture stop which is distanced forwardly of a front facing surface of the single-element lens by a distance which exceeds twice the focal length of the single-element lens.

Further in accordance with a preferred embodiment of the present invention there is no optical element having optical power interposed between the single-element lens used in the camera of the above-mentioned method and the scene.

Alternatively in accordance with a preferred embodiment of the present invention this camera includes an aperture stop which is distanced rearwardly of the center of a front facing surface of the single-element lens by a distance which is at least equal to the focal length of the single-element lens.

Further in accordance with a preferred embodiment of the present invention the camera used in the above-mentioned method includes a single element lens satisfying the following conditions:

5°<FOV<60° (1)

0.5<F<4 (2)

0.7f<r1<3.1f (3)

f<r2<infinity (4)

1.4<n<4.5 (5)

0.4f<bf<f (6)

0.05f<t<f (7)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens.

Preferably the single element lens used in the camera of the above-mentioned method satisfies the following conditions:

8°<FOV<35° (1)

0.7<F<2.8 (2)

0.7f<r1<3.1f (3)

f<r2<infinity (4)

2<n<4.5 (5)

0.7f<bf<f (6)

0.05f<t<0.3f (7)

−0.1f<d<10f (8)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens;

d is the position of the stop relative to the center of the front-facing surface of the lens—a positive value means that the stop is forward of the lens and a negative value means that the stop is behind the center of the front-facing surface of the lens.

More preferably the single element lens used in the camera of the above-mentioned method satisfies the following conditions:

80°<FOV<35° (1)

0.7<F<2.8 (2)

0.7f<r1<3.1f (3)

f<r2<infinity (4)

2<n<4.5 (5)

0.7f<bf<f (6)

0.05f<t<0.3f (7)

0.7f<d<13f (8)

where:

f is the focal length;

F is the f-number;

FOV is the field of view (diagonal full angle);

r1 is the radius of curvature of the front-facing convex surface of the lens;

r2 is the radius of curvature of the rear-facing concave (or flat) surface of the lens;

n is the refractive index of the lens material at a wavelength near the center of the spectral range being imaged;

bf is the back focal length between the center of the rear-facing surface of the lens and the Gaussian image plane;

t is the center thickness of the lens;

d is the position of the stop relative to the center of the front-facing surface of the lens—a positive value means that the stop is forward of the lens and a negative value means that the stop is behind the center of the front-facing surface of the lens.

### BRIEF DESCRIPTION OF THE DRAWINGS

The present invention will be understood and appreciated more fully from the following detailed description, taken in conjunction with the drawings in which:

FIG. 1 is a schematic view of a passenger car, equipped with a night vision system incorporating a FLIR camera, according to one preferred embodiment of the present invention;

FIG. 2 is a view from the driver's seat through the windshield, showing the position of the HUD image of the road ahead in front of the driver;

FIG. 3A is a cut-away view of the optical layout of the FLIR camera, showing the lens and detector array assemblies, with the aperture stop located in front of the lens;

FIG. 3B is a cut-away view of the optical layout of the FLIR camera, showing the lens and detector array assemblies, with the aperture stop located behind the lens;

FIG. 4 is a schematic diagram of a preferred embodiment of the focusing lens assembly, showing the parameters used to define the assembly;

FIG. 5A is a schematic view of the results of ray tracing through a preferred embodiment of an f/1.2 focusing lens assembly of the FLIR camera shown in FIG. 3A, using a germanium lens;

FIG. 5B is a graph of the polychromatic MTF obtained for the lens assembly shown in FIG. 5A, over a range of 8 to 12 μm;

FIGS. 6A and 6B are equivalent to FIGS. 5A and 5B, except that the focusing lens has an f/number of 1.4;

FIGS. 7A and 7B are equivalent to FIGS. 5A and 5B, except that the focusing lens has an f/number of 1.6; and

FIG. 8 is a schematic view of a further preferred embodiment of the present invention, in which the night vision system is mounted in a firefighter's helmet to allow improved vision in smoke-filled areas.

### DETAILED DESCRIPTION OF PREFERRED EMBODIMENTS

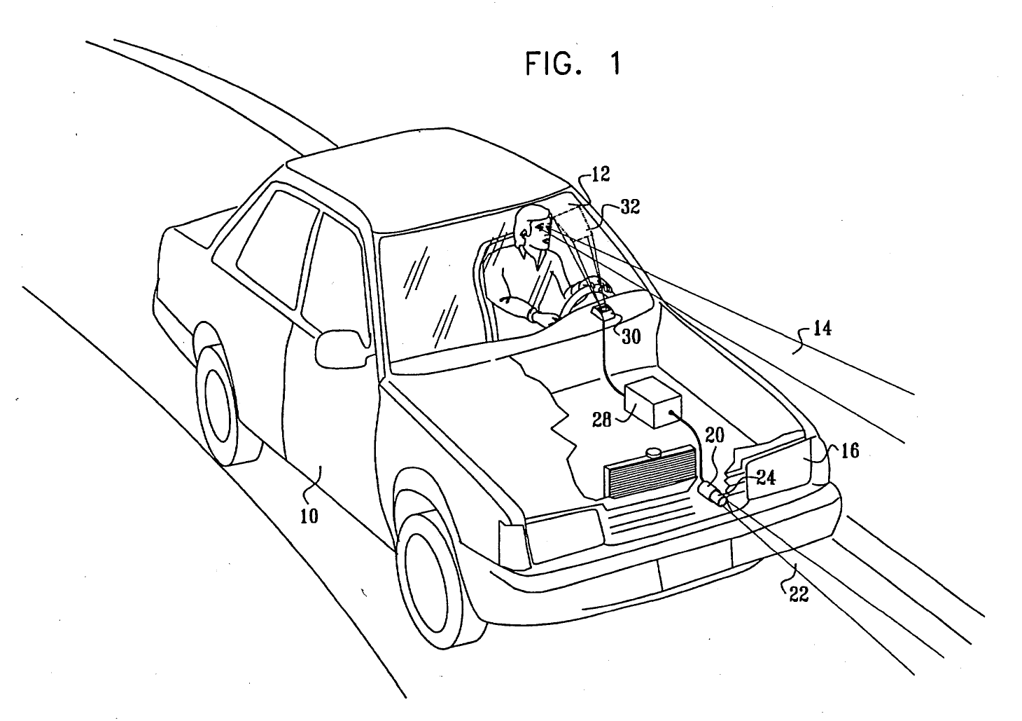

Reference is now made to FIG. 1, which schematically illustrates a car 10, equipped with a night vision system incorporating a FLIR camera, according to a preferred embodiment of the present invention. The driver 12 views the road ahead through a field of view 14. At night the road is illuminated as far ahead as possible and as brightly as possible by means of conventional headlights 16, with all the limitations mentioned in the background section hereinabove.

According to the present invention, a FLIR camera 20 is mounted at the front of the car, preferably behind a suitable gap in the front grill to protect it from mechanical damage. The camera views the infra red radiation emitted from the road scene ahead, from a narrow field of view 22. A preferred value of the field of view is of the order of 12° horizontally and 9° vertically. The FLIR camera is preferably mounted forward of the radiator 26, so that the heat radiated and convected from the radiator does not disturb or distort the IR view imaged by the camera.

The video signal from the camera, containing the real-time information about the IR view of the road ahead, is preferably conveyed to a signal processing and control unit 28, which is operative to take the detector outputs and process them into a form suitable for projecting a real-time video picture. The control unit may also preferably control the operation of the complete system. The processed video signal is preferably input to the projection unit 30 of a HUD, mounted in a suitable location in the instrument panel or in the fascia. Preferably, a monochrome video image is projected onto a specially prepared area 32 of the windshield of the car, slightly above the driver's view ahead of the road, the area preferably having a semi-transparent film coating, so that the projected video image is visible to the driver, while at the same time, the driver's view of the road is minimally affected. The driver can thus see an infra-red image of the road ahead in his windshield, without having to move his eyes significantly from his normal view of the road ahead.

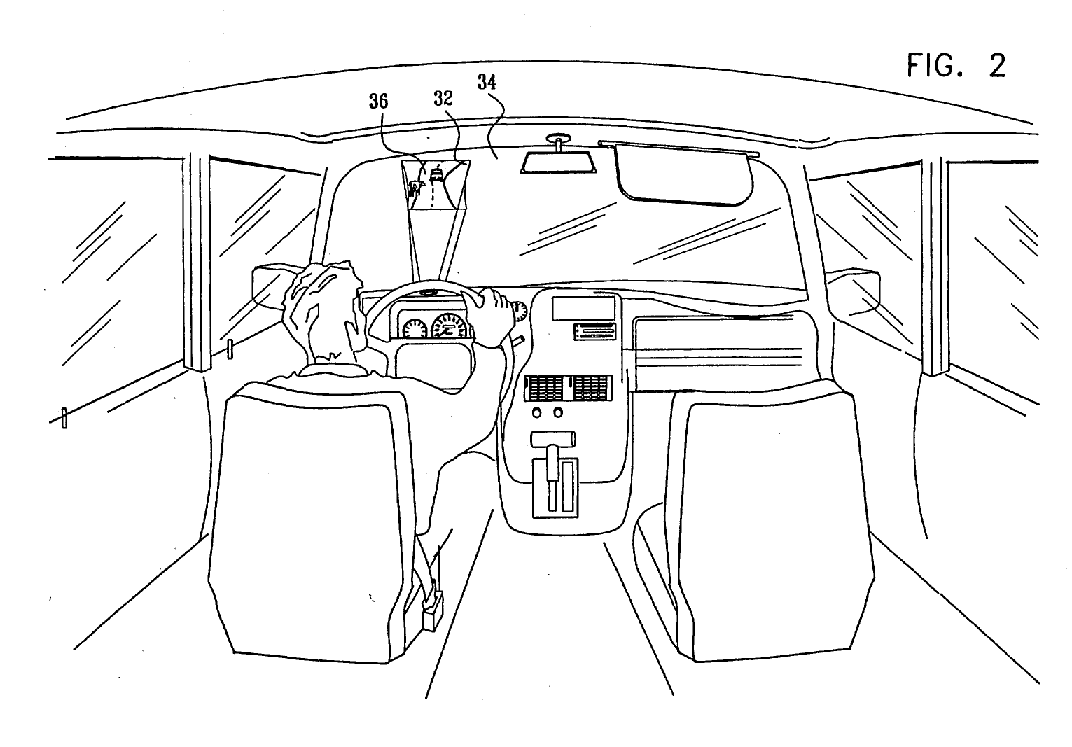

FIG. 2 is a schematic view from the driver's perspective, showing the HUD projection screen 32 located in the windshield 34 in front of the driver's eyes, and an IR video image 36 of the road ahead being shown on the screen.

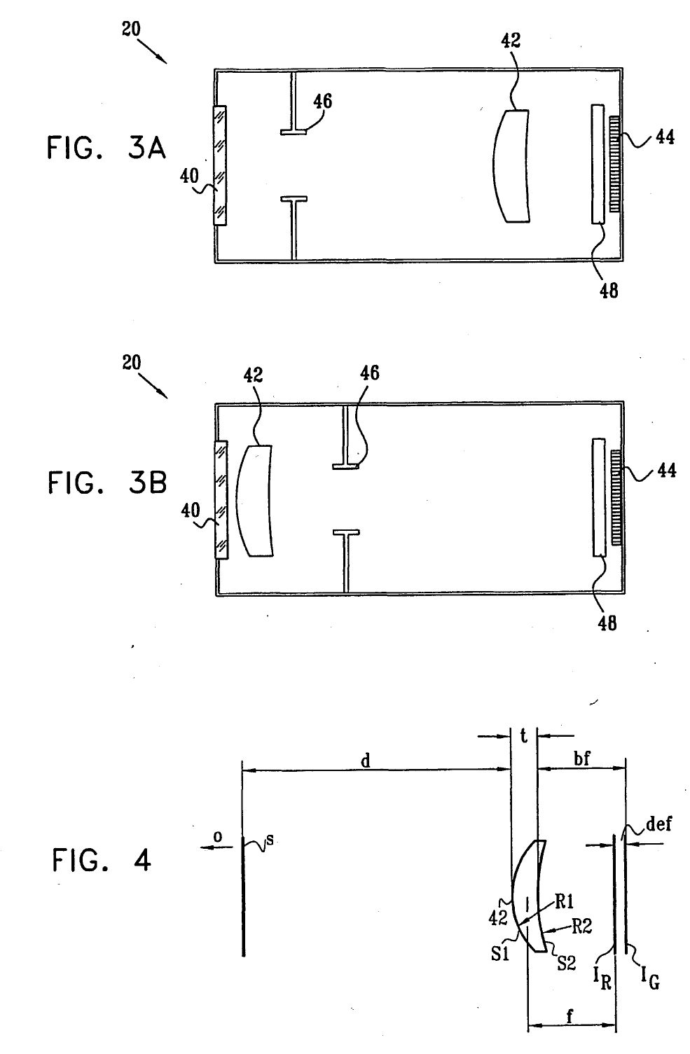

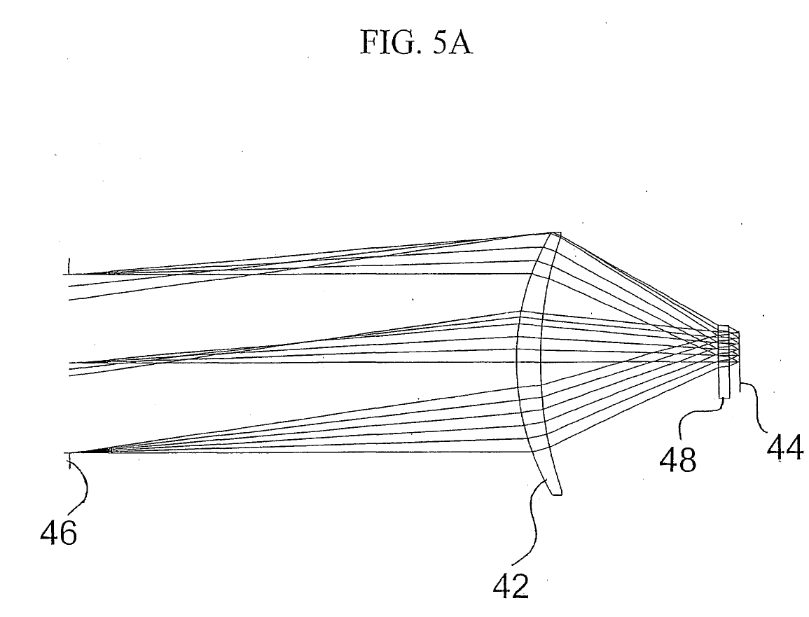

Reference is now made to FIG. 3A, which is a cut-away view of a preferred embodiment of the optical layout of the FLIR camera 20, schematically showing the disposition of the lens and detector array assemblies. The front aperture of the camera may be protected by means of a window 40, constructed of an IR transmissive material, preferably with a high hardness protective optical coating on its outer surface, as is known in the art. It is appreciated that the camera may be protected by another protective device or alternatively the camera may be used without a protective window 40. Beyond the entrance window there is an entrance aperture 46 disposed at a distance from the single-element focusing lens 42. The focusing lens is operative to focus an image onto the detector array 44. This detector array is known as a focal plane array FPA, and according to this preferred embodiment of the present invention, is composed of a two dimensional matrix of bolometer or ferroelectric elements. However, it is appreciated that other types of detectors may be used.

In front of the detector array 44, a protective window 48 is typically located. It is appreciated that the detector array 44 may be used without a protective window 48.

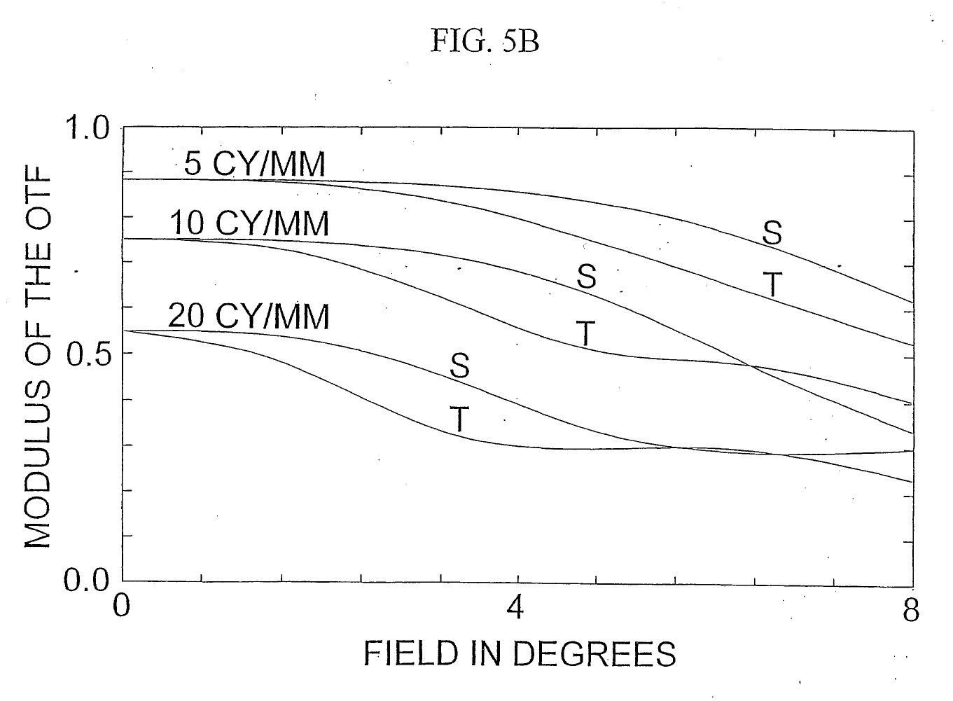

Reference is now made to FIG. 4, which is a schematic diagram of a preferred embodiment of the focusing lens assembly, showing the parameters used to define the assembly. The lens 42 is a thin positive lens, having a first convex surface S1 of radius of curvature R1, facing the object plane O, and a second concave surface S2 of radius of curvature R2 facing the Gaussian image plane I_{G}, which is the paraxial ray image forming position. The distance between the second surface S2 and the I_{G} plane is the back focal distance, denoted bf in FIG. 4. The distance between I_{G} and the real image plane I_{R} is the defocusing distance def. The center thickness of the lens is t. At a distance d from the first surface S1 of the lens, between the object plane O and the lens, is located an aperture stop S. The object plane itself is located effectively at infinity.

The lens can be constructed of any refractive infra red transmissive material for the wavelength range of interest. Preferable materials suitable for this use include germanium, zinc selenide, AMTIR, zinc sulfide, gallium arsenide and calcium fluoride. For the 3 to 5 micron wavelength region, silicon may also be preferably used. The refractive index of the lens material is denoted by n, and for the known suitable materials, the value of n can range between 1.4 and 4, with germanium, having a refractive index of 4, being the preferred choice for many FLIR applications.

In accordance with further preferred embodiments of the present invention, the lens may have asphericity added to one or to both of its surfaces, in order to further reduce the aberrations arising from the lens. In both of these cases, this should result in improved optical performance, and/or reduced lens thickness.

In accordance with yet further preferred embodiments of the present invention, the lens may have a diffractive optical profile on one of its surfaces. Such a diffractive profile is useful for reducing the effect of chromatic aberrations, especially when using materials such as zinc selenide.

The focal length f of the lens is determined by the dimensions of the detector array used and by the field of view required, according to the geometrical relationship well-known in the art:

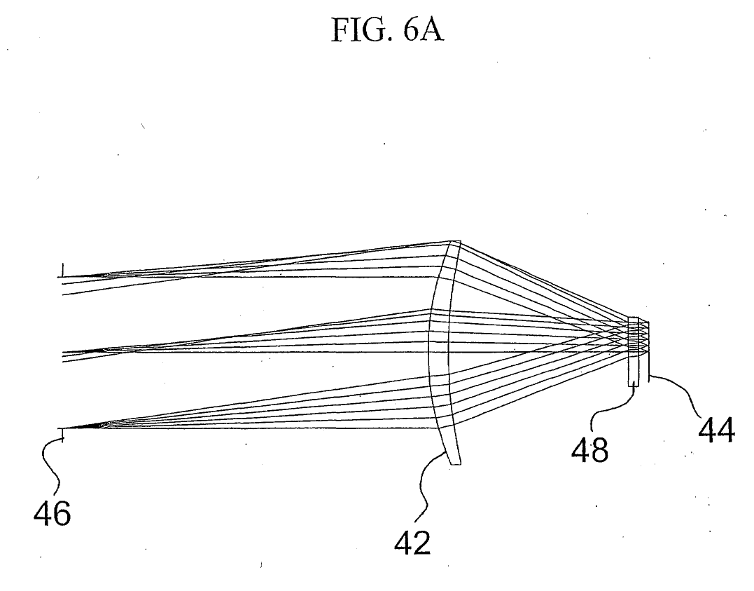

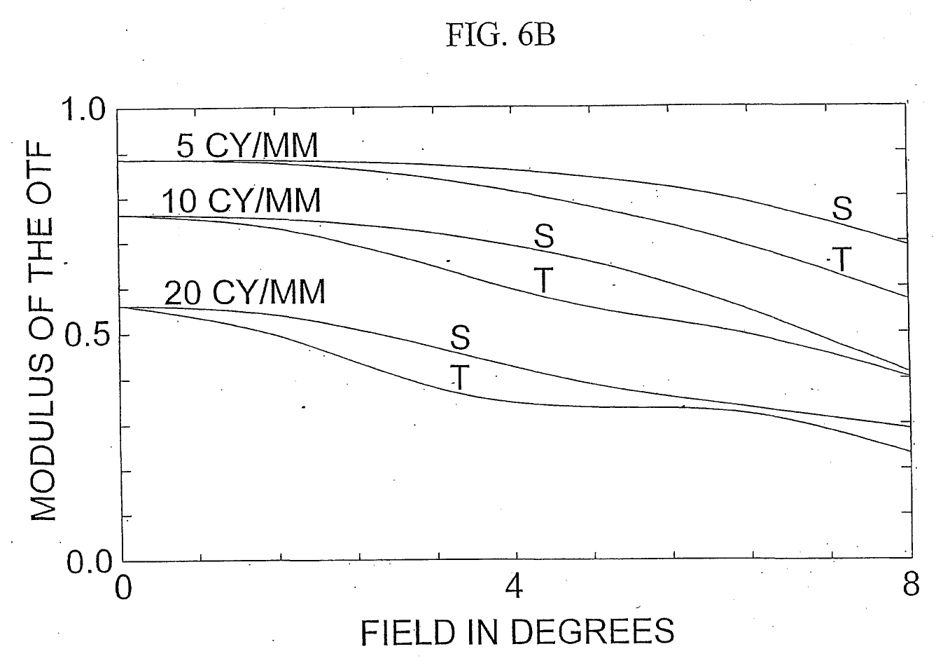

FOV=2 arctan(dd/2f)

where FOV is the full field of view angle, and dd is the diagonal dimension of the detector array. Thus, each different model of detector will require a lens of different focal length f, to maintain the required field of view. For the preferred examples shown below in FIGS. 5A to 7A, a detector having a 7 mm diagonal dimension was used. In order to use all of the detector surface, the most extreme rays from the field of view, i.e. those at ±8°, are required to hit the detector at its outermost point. This defines the required focal length of the lens as being 25 mm.

The required f/number of the lens is determined by the sensitivity of the detector array, and has to be low enough to ensure that enough radiation falls on the detector to provide a sufficiently strong signal.

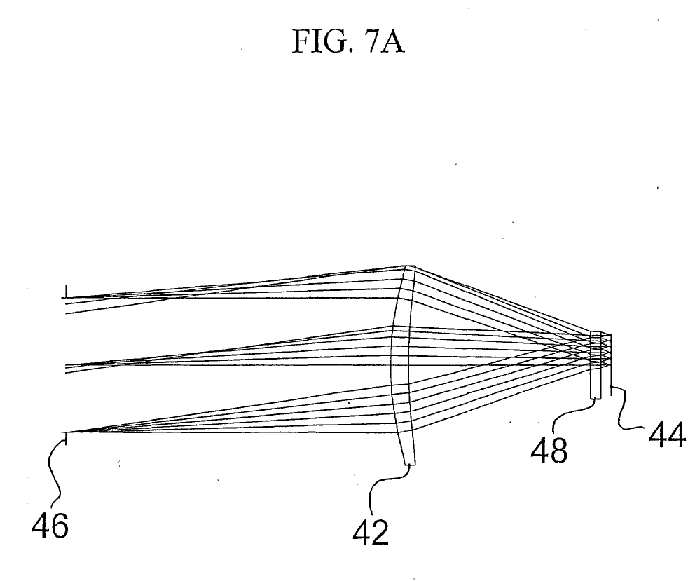

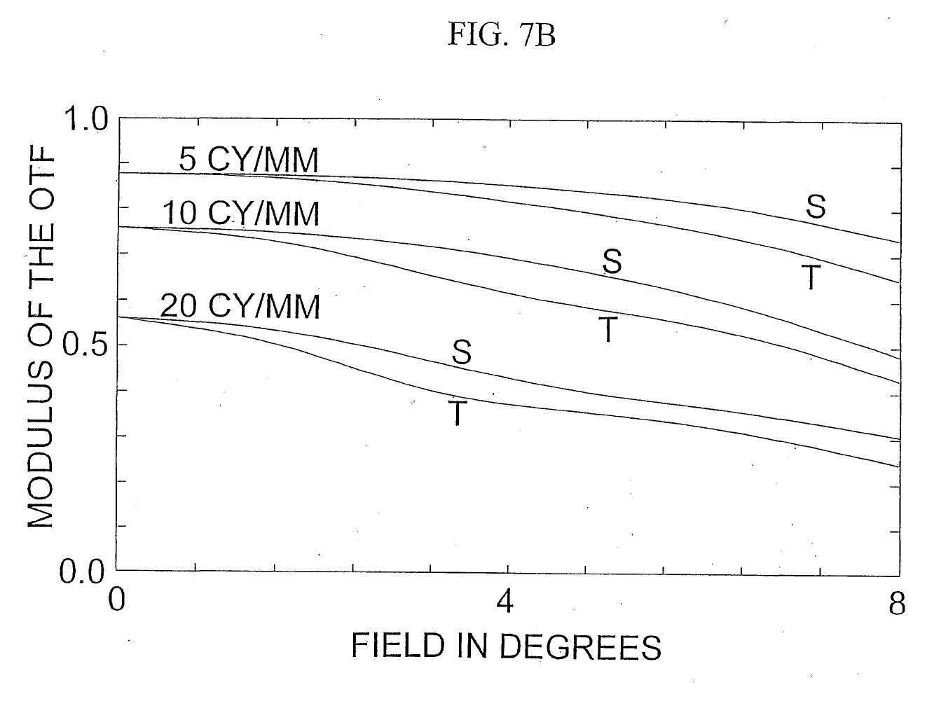

Reference is now made to FIGS. 5A, 6A and 7A, which show the results of ray tracing through three different preferred embodiments of a germanium focusing lens according to the present invention, obtained by means of an optimization process to maximize the chosen merit function. For these embodiments, the half-angle of the field of view was taken to be 8°, and the maximum dimension of the FPA (its diagonal) was taken to be 7 mm. Rays were traced for six different field positions. FIG. 5A shows an f/1.2 solution, FIG. 6A, an f/1.4 solution, and FIG. 7A, an f/0.6 solution.

FIGS. 5B, 6B and 7B show the polychromatic MTF obtained for these three respective cases, over the wavelength range of 8 to 12 μm. As is observed from these graphs, even though the lens assembly contains only a single-element lens, good optical performance is obtained, even for the f/1.2 embodiment.

The drawings show a plot of the Modulus of the OTF (Optical Transfer Function) versus points within the field of view. The plotted graphs demonstrate the contrast efficiency of the transfer of spatial frequencies from the object to the image for 3 different spatial frequencies, 5 cycles/mm (Spatial Freq. 1), 10 cycles/mm (Spatial Freq. 2) and 20 cycles/mm (Spatial Freq. 3). For each spatial frequency there are shown 2 plots, namely, the saggital (S1, S2 and S3) component and the tangential (T1, T2 and T3) component of the modulation. These plots are a measure of image sharpness as formed by the lens.

The plots show that at the center of the field of view (0°) the image sharpness is at its highest level for the 3 spatial frequencies. Moving across the field of view, there is seen a slight decrease in image sharpness. However, the plots show that the image is of acceptable quality.

The lens assembly parameters resulting from the optimization which resulted in these three embodiments of the invention, are given in Tables 1 to 3 hereinbelow, wherein Table 1 lists the parameters for FIGS. 5A and 5B, Table 2 lists the parameters for FIGS. 6A and 6B and Table 3 lists the parameters for FIGS. 7A and 7B.

The estimated weight of each lens is also given for comparison purposes.

TABLE 1

| | | | | | | |
|---|---|---|---|---|---|---|
| f/No. | = 1.2 | f | = 25 mm. | FOV | = 16° | n = |
| | | | | | | 4.0 |
| d | = 55 mm. | R1 | = 31.2 mm. | R2 | = 49.2 mm. | t = |
| | | | | | | 3 mm. |
| bf | = 24.64 mm. | def | =0.17 mm. | Weight | = 10.4 gm. | |

TABLE 2

| | | | | | | |
|---|---|---|---|---|---|---|
| f/No. | = 1.4 | f | = 25 mm. | FOV | = | n = |
| | | | | | 16° | 4.0 |
| d | = 45 mm. | R1 | = 33.3 mm. | R2 | = | t = |
| | | | | | 56.4 mm. | 2.5 mm. |
| bf | = 24.93 mm. | def | = 0.11 mm. | Weight | = | |
| | | | | | 6.9 mm. | |

TABLE 3

| | | | | | | |
|---|---|---|---|---|---|---|
| f/No. | = 1.6 | f | = 25 mm. | FOV | = | n = |
| | | | | | 16° | 4.0 |
| d | = 40 mm. | R1 | = 36.2 mm. | R2 | = | t = |
| | | | | | 66.7 mm. | 2.2 mm. |
| bf | = 25.12 mm. | def | = 0.07 mm. | Weight | = | |
| | | | | | 5.1 gm. | |

A feature of all of the preferred embodiments shown is that the aperture stop 46 (FIG. 3A) is located at a distance d from the lens 42, wherein the distance d is chosen for the type of lens used. Typical values of d for the germanium lens is in the range from 1.5f to 3f. In a second embodiment of the invention, the aperture stop 46 is located at a distance d on the image side of the lens 42, as shown in FIG. 3B. For this case, the distance d is defined as having negative values.

If the aperture stop is located close to the lens, the stop constrains the rays from all of the field points to go through the same parts of the lens. Under these circumstances, there is less freedom for the optimization process to correct aberrations at all field points even though it is possible to highly correct the central field of view of the lens. If the aperture is now moved to a distant location from the lens, rays from different parts of the field of view can go through different parts of the lens, thereby facilitating the opportunity to make better corrections to the entire field of the lens in the optimization process.

It is appreciated that in the three examples described hereinabove, the convex front surface is spherical, but the concave back surface is aspheric. The parameters for the aspheric lens surface can be obtained by optimization using any conventional Optical Design Software, such as Code V, as is known in the art and the respective lens parameters given in Tables 1, 2 and 3, hereinabove.

It is to be understood that the examples given hereinabove of the lens assembly of the present invention, are not to be taken as limiting the invention to the values expounded therein. Rather, different criteria for the merit figures used for the optimization process may result in different resulting lens assembly designs. Features common to all of them are the use of a single thin lens, with a range of parameters as designated in the summary section above, and an aperture stop preferably on the object side of the lens, located preferably at a distance of at least 1.5f in front of the first surface of the lens.

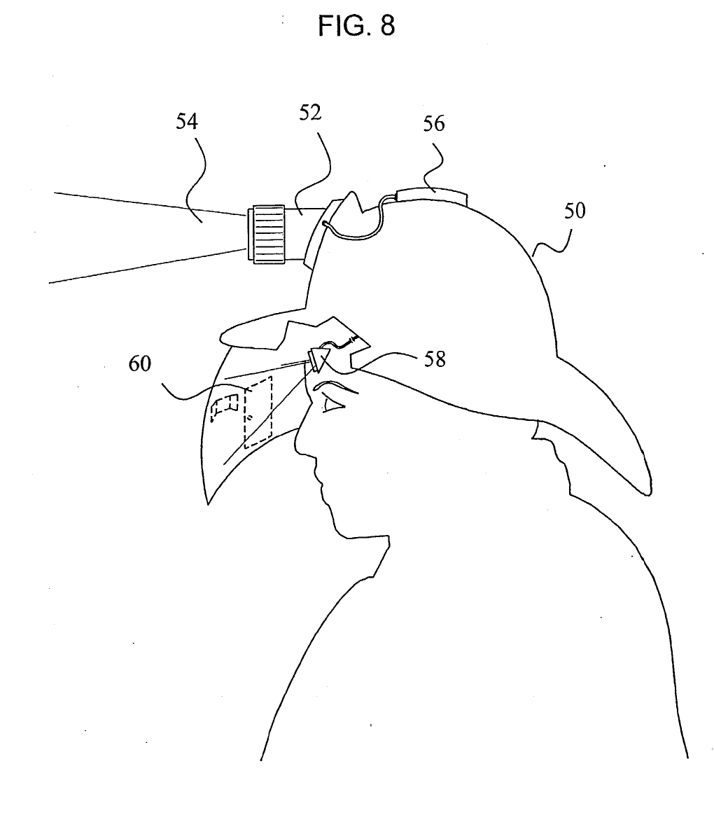

Reference is now made to FIG. 8, which is a schematic diagram of a preferred embodiment of a night vision system used for fire-fighting applications. Though termed a night vision system, it is understood that an important use of the system is for providing visibility through smoke and dust, which scatter visible radiation very strongly, but are significantly more transparent to infra-red radiation. In this preferred embodiment, the single element lens, the aperture stop and the infra-red detector are installed in a camera 52 mounted on the helmet 50 of the firefighter. The camera views the infra-red radiation 54 emitted from the area in front of the firefighter. The circuitry for processing the detector output is preferably mounted in a module 56 on top of the helmet. The image output from this module may preferably be projected onto the helmet visor 60 by any of the methods known in the art for visor display technology, such as a by means of a mini-projector element 58.

It will be appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

We claim:

1. A vehicular night vision system comprising:
an infra-red detector mounted on a vehicle;
a display mounted on said vehicle;
a focusing assembly for directing infrared radiation from a scene onto said infra-red detector, comprising a single-element lens, mounted upstream of said infra-red detector; and
circuitry operative to receive a detector output from said infra-red detector and to provide an image output based on said detector output to said display.

2. A vehicular night vision system according to claim 1 and wherein said single-element lens and said infra-red detector are mounted in a housing and together define an infra-red camera which is mounted by means of said housing on said vehicle in a forward looking orientation.

3. A vehicular night vision system according to claim 1 and wherein said display is a transparent display mounted on said vehicle so as to overlie at least a portion of a vehicle windshield.

4. A vehicular night vision system according to claim 2 and wherein said display is a transparent display mounted on said vehicle so as to overlie at least a portion of a vehicle windshield.

5. A vehicular night vision system according to claim 1 and wherein no optical element having optical power is interposed between said single-element lens and said scene.

6. A vehicular night vision system according to claim 2 and wherein said camera includes an aperture stop which is distanced forwardly of a front facing surface of said single-element lens by a distance which exceeds the focal length of said single-element lens.

7. A vehicular night vision system according to claim 2 and wherein said camera includes an aperture stop which is distanced forwardly of a front facing surface of said single-element lens by a distance which exceeds twice the focal length of said single-element lens.

8. A vehicular night vision system according to claim 4 and wherein said camera includes an aperture stop which is distanced forwardly of a front facing surface of said single-element lens by a distance which exceeds the focal length of said single-element lens.

9. A vehicular night vision system according to claim 4 and wherein said camera includes an aperture stop which is distanced forwardly of a front facing surface of said single-element lens by a distance which exceeds twice the focal length of said single-element lens.

10. A vehicular night vision system according to claim 8 and wherein no optical element having optical power is interposed between said single-element lens and said scene.

11. A vehicle having night vision functionality comprising:
a motor vehicle;
an infrared detector mounted on said vehicle;
a display mounted on said vehicle;
a focusing assembly for directing infrared radiation from a scene onto said infra-red detector, comprising a single-element lens only, mounted upstream of said infra-red detector; and
circuitry operative to receive a detector output from said infrared detector and to provide an image output based on said detector output to said display.

12. A vehicle having night vision functionality according to claim 11 and wherein said single-element lens and said infra-red detector are mounted in a housing and together define an infra-red camera which is mounted by means of said housing on said vehicle in a forward looking orientation.

13. A vehicle having night vision functionality according to claim 11 and wherein said display is a transparent display mounted on said vehicle so as to overlie at least a portion of a vehicle windshield.

14. A vehicle having night vision functionality according to claim 12 and wherein said display is a transparent display mounted on said vehicle so as to overlie at least a portion of a vehicle windshield.

15. A vehicle having night vision functionality according to claim 11 and wherein no optical element having optical power is interposed between said single-element lens and said scene.

16. A vehicle having night vision functionality according to claim 12 and wherein said camera includes an aperture stop which is distanced forwardly of a front facing surface of said single-element lens by a distance which exceeds the focal length of said single-element lens.

17. A vehicle having night vision functionality according to claim 12 and wherein said camera includes an aperture stop which is distanced forwardly of a front facing surface of said single-element lens by a distance which exceeds twice the focal length of said single-element lens.

18. A vehicle having night vision functionality according to claim 14 and wherein said camera includes an aperture stop which is distanced forwardly of a front facing surface of said single-element lens by a distance which exceeds the focal length of said single-element lens.

19. A vehicle having night vision functionality according to claim 14 and wherein said camera includes an aperture stop which is distanced forwardly of a front facing surface of said single-element lens by a distance which exceeds twice the focal length of said single-element lens.

20. A vehicle having night vision functionality according to claim 18 and wherein no optical element having optical power is interposed between said single-element lens and said scene.

21. A night vision system comprising:
an infra-red detector;
a display;
a focusing assembly for directing infrared radiation from a scene onto said infra-red detector, comprising a single-element lens only, mounted upstream of said infra-red detector; and
circuitry operative to receive a detector output from said infrared detector and to provide an image output based on said detector output to said display.

22. A night vision system according to claim 1 and wherein said single-element lens and said infra-red detector are mounted in a housing and together define an infra-red camera.

23. A night vision system according to claim 21 and wherein said display is a transparent display.

24. A night vision system according to claim 21 and wherein said display is a flat panel display.

25. A night vision system according to claim 21 and wherein no optical element having optical power is interposed between said single-element lens and said scene.

26. A night vision system according to claim 22 and wherein said camera includes an aperture stop which is distanced forwardly of a front facing surface of said single-element lens by a distance which exceeds the focal length of said single-element lens.

27. A night vision system according to claim 22 and wherein said camera includes an aperture stop which is distanced forwardly of a front facing surface of said single-element lens by a distance which exceeds twice the focal length of said single-element lens.

28. A night vision system according to claim 24 and wherein said camera includes an aperture stop which is distanced forwardly of a front facing surface of said single-element lens by a distance which exceeds the focal length of said single-element lens.

29. A night vision system according to claim 24 and wherein said camera includes an aperture stop which is distanced forwardly of a front facing surface of said single-element lens by a distance which exceeds twice the focal length of said single-element lens.

30. A night vision system according to claim 28 and wherein no optical element having optical power is interposed between said single-element lens and said scene.

31. A vehicular night vision method comprising the steps of:
mounting an infrared detector on a vehicle;
mounting a display on said vehicle;
providing a focusing assembly for directing infrared radiation from a scene onto said infra-red detector, comprising a single-element lens only, mounted upstream of said infra-red detector; and
receiving a detector output from said infrared detector and providing an image output based on said detector output to said display.

32. A vehicular night vision method according to claim 31 and wherein said single-element lens and said infra-red detector are mounted in a housing and together define an infra-red camera which is mounted by means of said housing on said vehicle in a forward looking orientation.

33. A vehicular night vision method according to claim 31 and wherein said display is a transparent display mounted on said vehicle so as to overlie at least a portion of said vehicle windshield.

34. A vehicular night vision method according to claim 32 and wherein said display is a transparent display mounted on said vehicle so as to overlie at least a portion of said vehicle windshield.

35. A vehicular night vision method according to claim 31 and wherein no optical element having optical power is interposed between said single-element lens and said scene.

36. A vehicular night vision method according to claim 32 and wherein said camera includes an aperture stop which is distanced forwardly of a front facing surface of said single-element lens by a distance which exceeds the focal length of said single-element lens.

37. A vehicular night vision method according to claim 32 and wherein said camera includes an aperture stop which is distanced forwardly of a front facing surface of said single-element lens by a distance which exceeds twice the focal length of said single-element lens.

38. A vehicular night vision method according to claim 34 and wherein said camera includes an aperture stop which is distanced forwardly of a front facing surface of said single-element lens by a distance which exceeds the focal length of said single-element lens.

39. A vehicular night vision method according to claim 34 and wherein said camera includes an aperture stop which is distanced forwardly of a front facing surface of said single-element lens by a distance which exceeds twice the focal length of said single-element lens.

40. A vehicular night vision method according to claim 38 and wherein no optical element having optical power is interposed between said single-element lens and said scene.

41. A vehicular night vision system according to claim 2 and wherein said camera includes an aperture stop which is distanced rearwardly of the center of a front facing surface of said single-element lens by a distance which is less than the focal length of said single-element lens.

42. A vehicular night vision system according to claim 4 and wherein said camera includes an aperture stop which is distanced rearwardly of the center of a front facing surface of said single-element lens by a distance which is less than the focal length of single-element lens.

43. A vehicle having night vision functionality according to claim 12 and wherein said camera includes an aperture stop which is distanced rearwardly of the center of a front facing surface of said single-element lens by a distance which is less than the focal length of single-element lens.

44. A vehicle having night vision functionality according to claim 14 and wherein said camera includes an aperture stop which is distanced rearwardly of the center of a front facing surface of said single-element lens by a distance which is less than the focal length of single-element lens.

45. A night vision system according to claim 22 and wherein said camera includes an aperture stop which is distanced rearwardly of the center of a front facing surface of said single-element lens by a distance which is less than the focal length of single-element lens.

46. A night vision system according to claim 24 and wherein said camera includes an aperture stop which is distanced rearwardly of the center of a front facing surface of said single-element lens by a distance which is less than the focal length of single-element lens.

47. A vehicular night vision method according to claim 32 and wherein said camera includes an aperture stop which is distanced rearwardly of the center of a front facing surface of said single-element lens by a distance which is less than the focal length of single-element lens.

48. A vehicular night vision method according to claim 34 and wherein said camera includes an aperture stop which is distanced rearwardly of the center of a front facing surface of said single-element lens by a distance which is less than the focal length of single-element lens.

49. A vehicular night vision system according to claim 1 and wherein said single element lens satisfies the following conditions:
5°<FOV<60° (1)
0.5<F<4 (2)
0.7f<r1<3.1f (3)
f<r2<infinity (4)
1.4<n<4.5 (5)
0.4f<bf<f (6)
0.05f<t<f (7)
where:
f is the focal length;
F is the f-number;
FOV is the field of view;
r1 is the radius of curvature of the front-facing convex surface of the lens;
r2 is the radius of curvature of the rear-facing surface of the lens;
n is the refractive index of the lens material at a wavelength near the center of the spectral range being imaged;
bf is the back focal length between the center of the rear-facing surface of the lens and the Gaussian image plane;
t is the center thickness of the lens.

50. A vehicular night vision system according to claim 1 and wherein said single element lens satisfies the following conditions:
8°<FOV<35° (1)
0.7<F<2.8 (2)
0.7f<r1<3.1f (3)
f<r2<infinity (4)
2<n<4.5 (5)
0.7f<bf<f (6)
0.05f<t<0.3f (7)
−0.1f<d<10f (8)
where:
f is the focal length;
F is the f-number;
FOV is the field of view;
r1 is the radius of curvature of the front-facing convex surface of the lens;
r2 is the radius of curvature of the rear-facing surface of the lens;
n is the refractive index of the lens material at a wavelength near the center of the spectral range being imaged;
bf is the back focal length between the center of the rear-facing surface of the lens and the Gaussian image plane;
t is the center thickness of the lens;
d is the position of the stop relative to the center of the front-facing surface of the lens wherein a positive value means that the stop is forward of the lens and a negative value means that the stop is behind the center of the front-facing surface of the lens.

51. A vehicular night vision system according to claim 1 and wherein said single element lens satisfies the following conditions:
8°<FOV<35° (1)
0.7<F<2.8 (2)
0.7f<r1<3.1f (3)
f<r2<infinity (4)
2<n<4.5 (5)
0.7f<bf<f (6)
0.05f<t<0.3f (7)
0.7f<d<10f (8)
where:
f is the focal length;
F is the f-number;
FOV is the field of view;
r1 is the radius of curvature of the front-facing convex surface of the lens;
r2 is the radius of curvature of the rear-facing surface of the lens;
n is the refractive index of the lens material at a wavelength near the center of the spectral range being imaged;
bf is the back focal length between the center of the rear-facing surface of the lens and the Gaussian image plane;
t is the center thickness of the lens;
d is the position of the stop relative to the center of the front-facing surface of the lens wherein a positive value means that the stop is forward of the lens and a negative value means that the stop is behind the center of the front-facing surface of the lens.

52. A vehicle having night vision functionality according to claim 11 and wherein said single element lens satisfies the following conditions:
5°<FOV<60° (1)
0.5<F<4 (2)
0.7f<r1<3.1f (3)
f<r2<infinity (4)
1.4<n<4.5 (5)
0.4f<bf<f (6)
0.05f<t<f< (7)
where:
f is the focal length;
F is the f-number;
FOV is the field of view;
r1 is the radius of curvature of the front-facing convex surface of the lens;
r2 is the radius of curvature of the rear-facing surface of the lens;
n is the refractive index of the lens material at a wavelength near the center of the spectral range being imaged;
bf is the back focal length between the center of the rear-facing surface of the lens and the Gaussian image plane;
t is the center thickness of the lens.

53. A vehicle having night vision functionality according to claim 11 and wherein said single element lens satisfies the following conditions:
8°<FOV<35° (1)
0.7<F<2.8 (2)
0.7f<r1<3.1f (3)
f<r2<infinity (4)
2<n<4.5 (5)
0.7f<bf<f (6)
0.05f<t<0.3f (7)
−0.1f<d<10f (8)
where:
f is the focal length;
F is the f-number;
FOV is the field of view;
r1 is the radius of curvature of the front-facing convex surface of the lens;
r2 is the radius of curvature of the rear-facing surface of the lens;
n is the refractive index of the lens material at a wavelength near the center of the spectral range being imaged;
bf is the back focal length between the center of the rear-facing surface of the lens and the Gaussian image plane;
t is the center thickness of the lens;
d is the position of the stop relative to the center of the front-facing surface of the lens wherein a positive value means that the stop is forward of the lens and a negative value means that the stop is behind the center of the front-facing surface of the lens.

54. A vehicle having night vision functionality according to claim 11 and wherein said single element lens satisfies the following conditions:
8°<FOV<35° (1)
0.7<F<2.8 (2)
0.7f<r1<3.1f (3)
f<r2<infinity (4)
2<n<4.5 (5)
0.7f<bf<f (6)
0.05f<t<0.3f (7)
0.7f<d<10f (8)
where:
f is the focal length;
F is the f-number;
FOV is the field of view;
r1 is the radius of curvature of the front-facing convex surface of the lens;
r2 is the radius of curvature of the rear-facing surface of the lens;
n is the refractive index of the lens material at a wavelength near the center of the spectral range being imaged;
bf is the back focal length between the center of the rear-facing surface of the lens and the Gaussian image plane;
t is the center thickness of the lens;
d is the position of the stop relative to the center of the front-facing surface of the lens wherein a positive value means that the stop is forward of the lens and a negative value means that the stop is behind the center of the front-facing surface of the lens.

55. A night vision system according to claim 21 and wherein said single element lens satisfies the following conditions:
5°<FOV<60° (1)
0.5<F<4 (2)
0.7f<r1<3.1f (3)
f<r2<infinity (4)
1.4<n<4.5 (5)
0.4f<bf<f (6)
0.05f<t<f (7)
where:
f is the focal length;
F is the f-number;
FOV is the field of view;
r1 is the radius of curvature of the front-facing convex surface of the lens;
r2 is the radius of curvature of the rear-facing surface of the lens;
n is the refractive index of the lens material at a wavelength near the center of the spectral range being imaged;
bf is the back focal length between the center of the rear-facing surface of the lens and the Gaussian image plane;
t is the center thickness of the lens.

56. A night vision system according to claim 21 and wherein said single element lens satisfies the following conditions:
8°<FOV<35° (1)
0.7<F<2.8 (2)
0.7f<r1<3.1f (3)
f<r2<infinity (4)
2<n<4.5 (5)
0.7f<bf<f (6)
0.05f<t<0.3f (7)
−0.1f<d<10f (8)
where:
f is the focal length;
F is the f-number;
FOV is the field of view;
r1 is the radius of curvature of the front-facing convex surface of the lens;
r2 is the radius of curvature of the rear-facing surface of the lens;
n is the refractive index of the lens material at a wavelength near the center of the spectral range being imaged;
bf is the back focal length between the center of the rear-facing surface of the lens and the Gaussian image plane;
t is the center thickness of the lens;
d is the position of the stop relative to the center of the front-facing surface of the lens wherein a positive value means that the stop is forward of the lens and a negative value means that the stop is behind the center of the front-facing surface of the lens.

57. A night vision system according to claim 21 and wherein said single element lens satisfies the following conditions:
8°<FOV<35° (1)
0.7<F<2.8 (2)
0.7f<r1<3.1f (3)
f<r2<infinity (4)
2<n<4.5 (5)
0.7f<bf<f (6)
0.05f<t<0.3f (7)
0.7f<d<10f (8)
where:
f is the focal length;
F is the f-number;
FOV is the field of view;
r1 is the radius of curvature of the front-facing convex surface of the lens;
r2 is the radius of curvature of the rear-facing surface of the lens;
n is the refractive index of the lens material at a wavelength near the center of the spectral range being imaged;
bf is the back focal length between the center of the rear-facing surface of the lens and the Gaussian image plane;
t is the center thickness of the lens;
d is the position of the stop relative to the center of the front-facing surface of the lens wherein a positive value means that the stop is forward of the lens and a negative value means that the stop is behind the center of the front-facing surface of the lens.

58. A vehicular night vision method according to claim 31 and wherein said single element lens satisfies the following conditions:
5°<FOV<60° (1)
0.5<F<4 (2)
0.7f<r1<3.1f (3)
f<r2<infinity (4)
1.4<n<4.5 (5)
0.4f<bf<f (6)
0.05f<t<f (7)
where:
f is the focal length;
F is the f-number;
FOV is the field of view;
r1 is the radius of curvature of the front-facing convex surface of the lens;
r2 is the radius of curvature of the rear-facing surface of the lens;
n is the refractive index of the lens material at a wavelength near the center of the spectral range being imaged;
bf is the back focal length between the center of the rear-facing surface of the lens and the Gaussian image plane;
t is the center thickness of the lens.

59. A vehicular night vision method according to claim 31 and wherein said single element lens satisfies the following conditions:
8°<FOV<35° (1)
0.7<F<2.8 (2)
0.7f<r1<3.1f (3)
f<r2<infinity (4)
2<n<4.5 (5)
0.7f<bf<f (6)
0.05f<t<0.3f (7)
−0.1f<d<10f (8)
where:
f is the focal length;
F is the f-number;
FOV is the field of view;
r1 is the radius of curvature of the front-facing convex surface of the lens;
r2 is the radius of curvature of the rear-facing surface of the lens;
n is the refractive index of the lens material at a wavelength near the center of the spectral range being imaged;
bf is the back focal length between the center of the rear-facing surface of the lens and the Gaussian image plane;
t is the center thickness of the lens;
d is the position of the stop relative to the center of the front-facing surface of the lens wherein a positive value means that the stop is forward of the lens and a negative value means that the stop is behind the center of the front-facing surface of the lens.

60. A vehicular night vision method according to claim 31 and wherein said single element lens satisfies the following conditions:
8°<FOV<35° (1)
0.7<F<2.8 (2)
0.7f<r1<3.1f (3)
f<r2<infinity (4)
2<n<4.5 (5)
0.7f<bf<f (6)
0.05f<t<0.3f (7)
0.7f<d<10f (8)
where:
f is the focal length;
F is the f-number;
FOV is the field of view;
r1 is the radius of curvature of the front-facing convex surface of the lens;
r2 is the radius of curvature of the rear-facing surface of the lens;
n is the refractive index of the lens material at a wavelength near the center of the spectral range being imaged;
bf is the back focal length between the center of the rear-facing surface of the lens and the Gaussian image plane;
t is the center thickness of the lens;
d is the position of the stop relative to the center of the front-facing surface of the lens wherein a positive value means that the stop is forward of the lens and a negative value means that the stop is behind the center of the front-facing surface of the lens.

61. A vehicular night vision system according to claim 1 and wherein said single element lens has at least one surface aspheric.

62. A vehicular night vision system according to claim 1 and wherein said single element lens has both surfaces aspheric.

63. A vehicular night vision system according to claim 1 and wherein said single element lens comprises a diffractive optical profile on at least one of its surfaces.

64. A vehicle having night vision functionality according to claim 11 and wherein said single element lens has at least one surface aspheric.

65. A vehicle having night vision functionality according to claim 11 and wherein said single element lens has both surfaces aspheric.

66. A vehicle having night vision functionality according to claim 11 and wherein said single element lens comprises a diffractive optical profile on at least one of its surfaces.

67. A night vision system according to claim 21 and wherein said single element lens has at least one surface aspheric.

68. A night vision system according to claim 21 and wherein said single element lens has both surfaces aspheric.

69. A night vision system according to claim 21 and wherein said single element lens comprises a diffractive optical profile on at least one of its surfaces.

70. A vehicular night vision method according to claim 31 and wherein said single element lens has at least one surface aspheric.

71. A vehicular night vision method according to claim 31 and wherein said single element lens has both surfaces aspheric.

72. A vehicular night vision method according to claim 31 and wherein said single element lens comprises a diffractive optical profile on at least one of its surfaces.
